(19) United States
(12) Patent Application Publication
(10) Pub. No.: US 2024/0401575 A1
(43) Pub. Date: Dec. 5, 2024

(54) Displaced Inertia Distributed Accelerator

(71) Applicant: Steven Mark Schulz, Baton Rouge, LA (US)

(72) Inventor: Steven Mark Schulz, Baton Rouge, LA (US)

(21) Appl. No.: 18/762,936

(22) Filed: Jul. 3, 2024

(51) Int. Cl. F03G 7/10

(52) U.S. Cl. CPC F03G 7/115

(57) ABSTRACT

This invention harvests some inertia from moving spheres to transfer thrust to the device. The invention has a track generally in the shape of a racetrack, that uses balls which are accelerated along the extended section of the racetrack toward the rear direction of the general forward motion produced by the device. The balls initial acceleration on the track produces a recoil adding to the forward motion of the device. This recoil is then counteracted via the ball traversing around the back of the U shaped race track, bleeding off some inertia. The balls continue around the rear track to the forward leg of the straight section where the excess inertia is bled off by friction means to add to the forward motion of the track. The balls, depleted of most of their inertia, continue around the front section and on to the acceleration means located on the rear facing leg and repeat the cycle.

Related U.S. Application data

| | |
|---|---|
| US CL | 74/83; 244/171.5 |
| Field of | 74/5.34, 5.37, 74/5.22, 5.42, 5.46, 5.47, 5.7, 5.12, 194, 14, |
| Search | 845, 84 R, 84 S, 5.95, 5.6; 114/360; 244/79, 93, 165, 3.21, |
| | 3.23, 165, 62, 165, 171.5; 180/7, 7.1; 310/12; 60/200.1. |

References Cited
US Patent Documents

| | | | |
|---|---|---|---|
| 1,811,465 | June 1931 | Geloso | 74/194 X |
| 1,953,964 | April 1934 | Laskowitz | 74/14 |
| 2,432,430 | December 1947 | Luboshez | 74/5.37 |
| 2,752,791 | July 1956 | Jarosh et al. | 74/5.6 D |
| 2,856,142 | October 1958 | Haviland | 244/93 |
| 2,857,122 | October 1958 | Maguire | 244/93 |
| 2,953,926 | September 1960 | Wrigley et al. | 74/5.37 |
| 3,006,581 | October 1961 | Langman | 74/5.37 X |
| 3,199,362 | August 1965 | Pfeiffer | 74/DIG.4 |
| 3,203,644 | August 1965 | Kellogg, Jr. | 180/7.1 X |
| 3,214,982 | November 1965 | Sylvia | 74/5.7 |
| 3,456,513 | July 1969 | Emerson | 74/5.47 |
| 3,555,915 | January 1971 | Young, Jr. | 74/84 |
| 3,584,515 | June 1971 | Matyas | 74/84 |
| 3,653,269 | April 1972 | Foster | 74/84 |
| 3,807,244 | April 1974 | Estrade | 74/84 S |
| 3,968,700 | July 1976 | Cuff | 74/84 S |
| 4,095,460 | October 1983 | de Weaver | 74/84 S |
| 4,770,063 | September 1988 | Mundo | 74/84 S |
| 4,825,716 | May 1989 | Roberts et al. | 74/5.34 |
| 5,685,196 | November 1997 | Foster, Sr. | 74/84 |
| 5,831,354 | November 1988 | Stopplecamp | 310/12 |
| 5,860,317 | January 1999 | Laitheaite et al. | 74/5.34 |
| 5,890,400 | April 1999 | Oades | 74/845 |
| 5,966,986 | September 1999 | Laul | 74/84 |
| 6,109,123 | August 2000 | Baskis et al. | 74/89.1 |
| 6,340,137 | January 2002 | Davis et al. | 244/165 |
| 7,165,388 | January 2007 | Brady | 60/200.1 |
| 7,383,747 | June 2008 | Tippett | 74/5.22 |
| 7,458,201 | December 2008 | Brady | 60/200.1 |
| 7,832,297 | January 2010 | Hewatt | 74/5.12 |
| 7,900,874 | March 2011 | Fiala et al. | 244/171.5 |
| 9,551,994 | January 2017 | Becker et al. | 1/0883 |
| 8,234,943 | August 2012 | Tippett | 74/5.37 |
| 8,742,633 | June 2014 | Hunter et al. | 7/065 |
| 8,981,608 | March 2015 | Ariel | 53/00 |
| 10,053,242 | August 2018 | Yew et al. | 1/283 |
| 10,294,927 | May 2019 | Hawk | 3/00 |
| 10,551,189 | February 2020 | McGuinness et al. | 19/02 |
| 10,882,640 | January 2021 | Lui et al. | 1/242 |
| 11,047,369 | June 2021 | Abers | 3/08 |
| 11,236,734 | February 2022 | Carew | 1/46 |
| 11,536,254 | December 2022 | Arbabian | 3/02 |
| 11,724,831 | August 2023 | Bado et al. | 1/409 |
| 11,738,888 | August 2023 | Filipi et al. | 1/283 |

### FIELD OF THE INVENTION

### Displaced Inertia Distributed Acceleration (DIDA)

The invention is related to an apparatus and method for providing linear motion without reaction from an external environment.

### BACKGROUND OF THE INVENTION

NASA began the “Breakthrough Propulsion Physics Project” in 1966 with the aim of finding unique solutions to the problem of reaction-less propulsion. However after 6 years and many submitted papers, they never had a clear solution to the problem. NASA did identify many non-viable approaches to this issue and I have listed some of these below:
Oscillation Thrusters and Gyroscopic style devices were examined and determined to be ineffective in a space environment for any meaningful thrust.
Hooper Anti-gravity Coils have not been able to show any thrust through experimentation and testing.
Schilicher Thrusting Antenna was also unable to provide any evidence of thrust.
Podkletmov Gravity Shield is another approach that has failed to show any results from experiments.
Coronal Blowers are another method that was looked at and found non effective in a space environment.

### DESCRIPTION OF RELATED ART

As of this application there are very few methods that survived testing. Joseph Brady U.S. Pat. No. 7,458,201 teaches us that one way to achieve some thrust is by utilizing a phase change and a closed loop. There are many patents and devices that utilize a closed loop system and the present invention does require a feedback arrangement. That is where the similarities diverge. While a loop in the general form of an oval is the main embodiment in this invention it is recognized that an infinite variety of shapes can achieve the basic feedback requirement in this invention.

The field of reaction propulsion mechanisms is extensive and as referenced falls in several categories that have been shown as of this invention to be ineffective for thrust applications. Bricio Arzubide Pub. No.: US20220120341A1 teaches us a device with some scalability but suffers from mechanical complexity and inertia harvesting limitation. Von Bargen Pat. No. 11,149,719 B2 teaches us of a version of Inertia Displacement. The device depends on the recoil or reflection of a mass and the ability to capture some of the inertia of this event. It is limited by several factors: the resilience and flexibility of the material enabling the bounced weight, the complexity of the actuation involved in creating these bounced impulses and the limitation on the weights involved.

### GENERAL DESCRIPTION OF THE INVENTION

The presented mechanism is very simple and utilizes a substantially oval track to contain the moving mass units that travel within the track. The invention can be divided generally into four cycles. 1^{st} is the acceleration segment. The Hallmark of this invention presents the accelerating means that fires projectiles toward the rear and aligns with the long axis of the general racetrack shape. The acceleration means fires the units or spheres toward the rear U-shaped section, essentially in reverse of the direction of accumulated thrust and travel. The 1^{st} sequence starts by accelerating the spheres along the generally strait section of the oval race track configuration. The mass being accelerated in the drawings is a solid sphere that is accelerating down the track and like any force the reaction or recoil to the device referred to as the track is opposite and equal to the accelerated steel ball and provides a thrust toward the front of the device.

The 2^{nd} cycle occurs when the balls travel around the back U shaped section. The ball is basically Displaced around the U-shaped section that counteracts the recoil and provides some negative thrust to the forward movement. The U-shaped section slows the balls and that is the feedback cycle. The invention depends on meeting a threshold value on the initial acceleration phase in order to retain inertia in the bleed off-phase. The balls remaining Inertia is substantially retained as it journeys down the opposite or forward facing side of the track. The balls on this side of the track are moving toward the forward direction of the track. This is the 3^{rd} cycle and offers resistance to the balls speed in order to bleed-off the inertia and Distribute it to the major axis of the mechanism referred to as the track. This transfers some Acceleration by bleeding off some speed of the spheres to the track along the major axis realizing a positive thrust in the forward direction.

The inertia of those spheres is ultimately drained to a point that allows the ball a residual speed to return to the initial acceleration leg. A bounce plate embodiment referenced by FIG. 6 reduces the speed very quickly, the balls in this version also retain enough momentum to return to the firing means, completing the 4^{th} cycle, this completes the balls revolution around the track and the sequence starts again.

### BRIEF DESCRIPTION OF THE DRAWINGS

FIG. 1 is a perspective view of a simple embodiment of the device.

FIG. 2 is a top view of the simple version in FIG. 1.

FIG. 3 is a perspective view of an improved embodiment of the invention.

FIG. 4 is a top see through view of FIG. 3.

FIG. 5 is a perspective see through view of a different angle of FIG. 3.

FIG. 6 is a perspective view of the preferred embodiment using a bounce plate.

### DESCRIPTION OF THE DRAWINGS

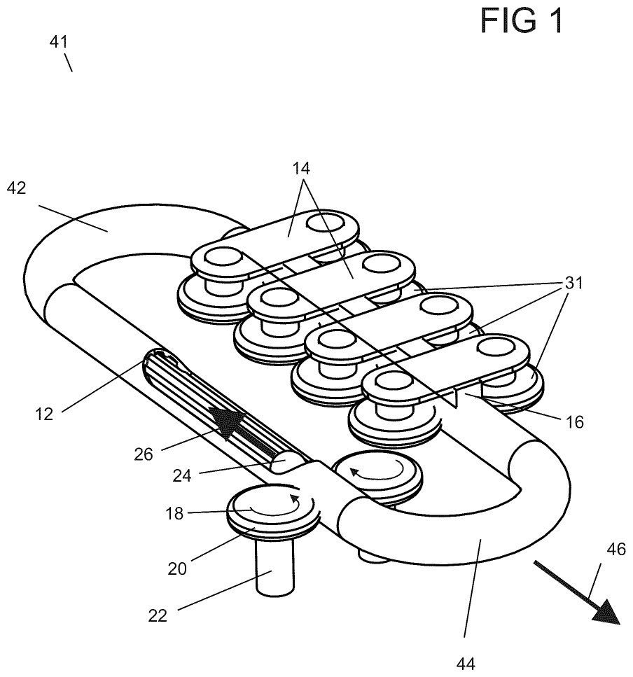

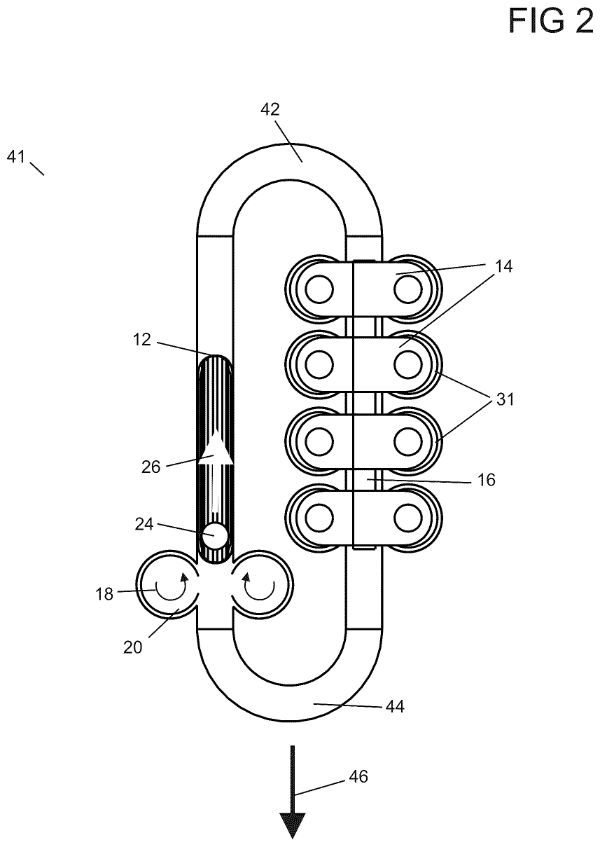

Referring now to FIG. 1 and FIG. 2, this embodiment is referenced as 41 and is designed to generate a thrust in the forward direction referenced by arrow 46. A ball 24 is shown being accelerated toward the rear of the machine by arrow 26 and propelled by the wheels 20 operated by the motor 22 and turning in the direction displayed by 18. The cutaway referenced by 12 shows the ball racing toward the rear section referred to as 42 of the device, ball 24 will travel around the U shaped section 42 and continue toward the front, indicated as section 44 of the invention. This embodiment utilizes friction wheels 31 attached to the frame of the device via brackets 14 and 16. The friction wheels 31 offer resistance to any balls traveling along the section comprised of the 31 wheels. The friction wheels slow the traveling balls, such as ball 24 through resistance to the balls trajectory. This resistance imparts some of the thrust initially inherent in the balls inertia through the brackets 14 and 16 to ultimately accumulate that thrust to the mechanism indicated by 41 in the direction shown by arrow 46.

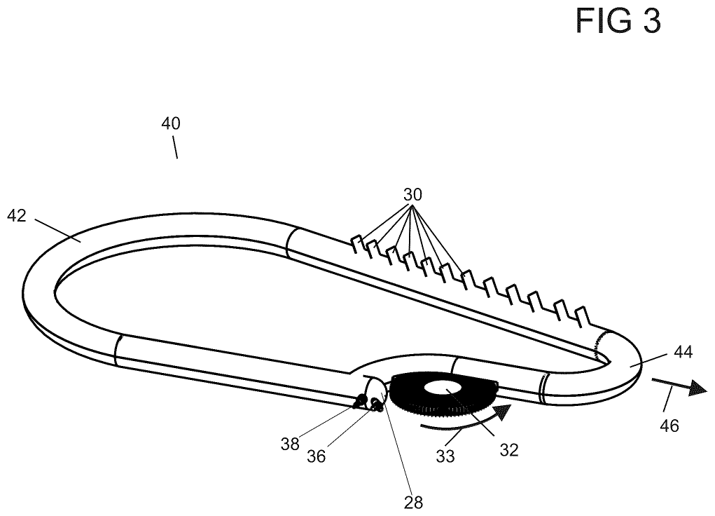

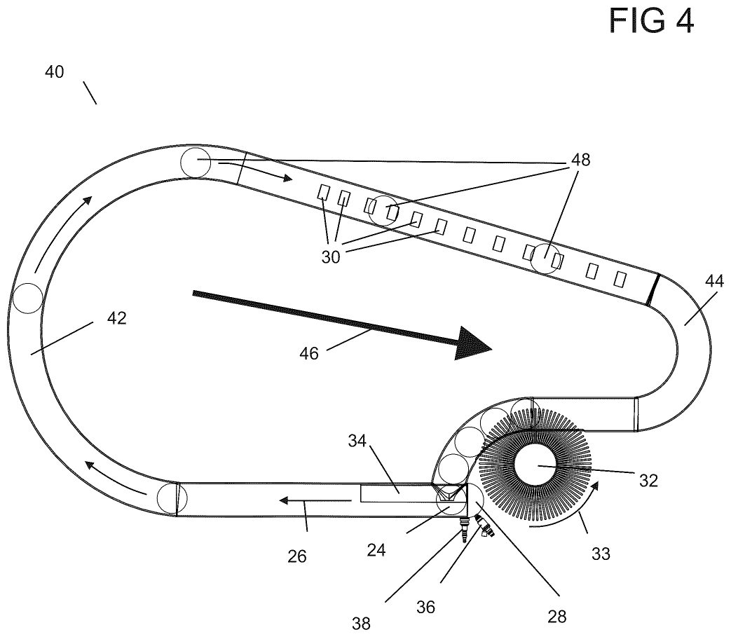

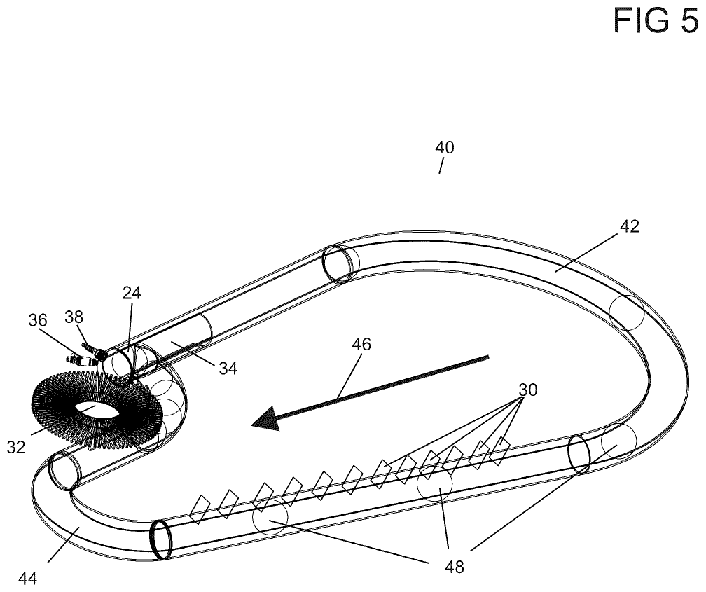

The embodiment referenced by FIG. 3 through FIG. 5 depict device indicated as 40 that obeys the same principle as the forces indicated by FIG. 1 & FIG. 2. The major difference is the means of propulsion shown in FIG. 3 as the combustion or expansion chamber 28. The sequence for this device is controlled by the rotating wheel 32. The wheel 32 rotates in the direction indicated by 33 and the rotation provides a means of accumulating the balls generally referenced by 48 in FIG. 4 and FIG. 5. This rotating wheel provides a force to the spent balls as they finish the sequence and travel around the front U section 44 of the device with enough inertia to reach the wheel 32. The balls at this stage are swept toward the combustion chamber 28 and staged to enter the firing sequence in turn. This can be readily viewed in FIG. 4 as the balls are swept toward the combustion chamber 28.

Once the active ball is fired from the combustion chamber 28 and accelerated toward the rear section 42 indicated by the direction arrow 26 in FIG. 4, the chamber is discharged and the bolt 34 slide forward to accommodate a ball in the Queue. Once the ball enters the firing chamber directly in front of the combustion chamber 28 as indicated by ball 24, the bolt 34 slides back to provide and air tight chamber in preparation for the next firing sequence. In this embodiment fuel is introduced to the chamber using fuel injector 36 and fired with spark plug 38. The ball is then accelerated toward the rear section 42 of the invention shown by arrow 26. This action cycles the bolt forward as the ball races out of the chamber and creates an opening for another ball in the Queue to move into the chamber and continue the cycle.

Once the ball is fired it continues through the rear U section 42 and makes its way to the series of friction elements 30. These friction elements are designed to resist the balls speed and transmit that inertia to the device. Once the balls travel through the series of resistance plates 30, the inertia of the ball is drained and this inertia is transferred to the machine 40 propelling the machine forward indicated by arrow 46. Not shown in these drawings is the alternate method of propelling the balls using highly compressed gas instead of combustible accelerant.

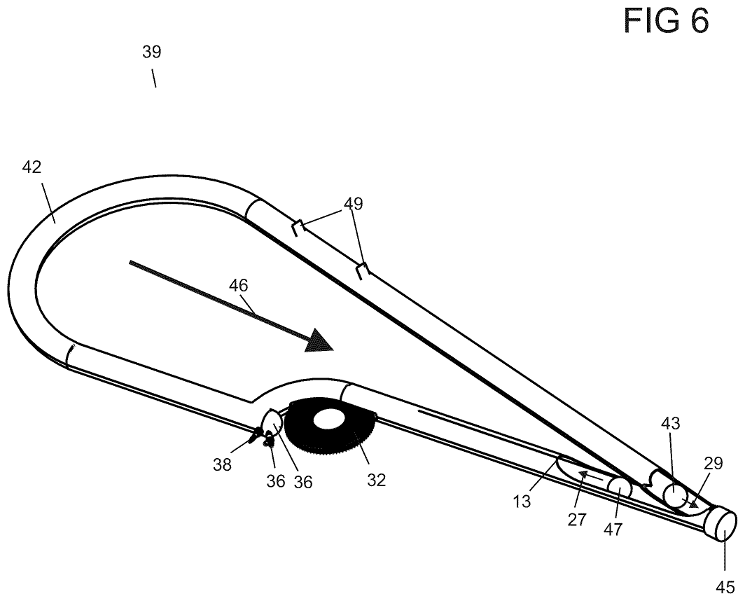

The drawing in FIG. 6 depicts the preferred embodiment of the device that uses a bump plate 45 instead of the U shaped front section indicated in previous embodiments. FIG. 6 version of the device is indicated by the reference 39 and demonstrates a slightly different method to reduce the balls inertia quickly by utilizing a modified stiff plate 45 designed to harvest the initial inertia of the incoming ball and ricochet the incoming ball toward the wheel 32 with enough force to make it to this section. The balls under acceleration travel through the rear section 42 and enter the strait segment headed for the bump plate 45. Friction elements designated 49 are designed to reduce the speed incrementally in order to time the balls headed for the bump plate 45 so they have clearance to ricochet from bump plate 45 without interfering with other incoming balls. The bump plate 45 is designed to have some flexibility and allow the bump plate to reduce the incoming balls speed and harvest the inertia. Cutaway drawing 13 shows the incoming ball indicated by 43 and direction arrow 29 heading directly to bump plate 45 and transferring the inertia to device 39 in the forward direction indicated by arrow 46 and generated via the bump plate's physical attachment to the device 39.

While bump plate 45 harvests the majority of the ball's inertia, it is designed to allow some residual speed to the ricocheted balls shown as ball 47 indicated travel by arrow 27 that allows the balls to reach the accumulation wheel 32 and finish the sequence. The cycle is then repeated similar to device 40 and each ball is ultimately sequenced into the combustion chamber 28 and fired via the fuel injector 36 and spark plug 38. Not shown are the alternative firing process using highly compressed gas injected suddenly into the chamber 28 to propel the ball forward.

1. A propulsion system that includes an enclosed track generally shaped in a racetrack configuration designed to accelerate and decelerate balls along said track for the purpose of harvesting some inertia that adds to propulsion.

2. Propulsion system according to claim 1, wherein said propulsion device has an acceleration means aligned with the strait leg of the said race track, oriented toward shooting the said balls toward the rear section of the race track and through the rear U section of track reversing the balls direction.

3. Propulsion system according to claim 2, further provides a means of slowing said balls traveling along the strait section of the forward leg of said track and to harvest through friction or other means the inertia of said balls and impart the thrust to the said track and create a forward force of motion aligned with the preferred axis and directed toward the forward axis of the stated strait section of track, the balls continue around the front U shaped track and return to the rear facing strait section of track, now depleted of most of their momentum and continue through the acceleration section to repeat the cycle.

4. A propulsion system designed to accelerate and decelerate balls along said track that includes two generally aligned tracks using a U shaped section to connect the rear section of said tracks with the front section of track connected using a bump plate membrane designed to harvest the said balls inertia while reversing the said balls direction by bouncing the ricocheted said balls toward the rear direction to begin the acceleration sequence again.

5. A propulsion system according to claim 4, wherein said propulsion device sets up the said balls to continue around the said propulsion device by providing a means of accelerating the spent said balls toward the rear U shaped section and continuing around the said rear U segment and proceeding in the forward direction onto the said bump plate to begin the cycle again.
